(19) United States
(12) Patent Application Publication
(10) Pub. No.: US 2024/0167591 A1
(43) Pub. Date: May 23, 2024

(54) WATER DISCHARGE VALVE

(71) Applicant: Huizhou Licheng Inflatable Toys Product Co.,Ltd., Huizhou (CN)

(72) Inventor: Tianxing Zhang, Nanchong (CN)

(21) Appl. No.: 18/058,711

(22) Filed: Nov. 23, 2022

(51) Int. Cl. F16L 15/00

(52) U.S. Cl. CPC F16L 15/00; A01K 7/02

(57) ABSTRACT

The present disclosure provides a water discharge valve, including a base, a threaded seat, a fixing column, an outer housing, and a top cover, the base is fixed with the threaded seat, a bottom of the threaded seat is fixed with the top portion of the base, the threaded seat is formed with a connecting column, an outer sidewall of the connecting column is formed with an external thread, a top portion of the threaded seat is provided with a connecting column, the fixing column is hollow, and a bottom of the fixing column defines an opening, a lower portion of an inner wall of the fixing column is formed with an internal thread, the threaded seat is threadedly connected with the fixing column, a first sliding rail and a second sliding rail are arranged on the fixing column, the first sliding rail faces the second sliding rail.

### TECHNICAL FIELD

The present disclosure relates to the technical field of pet supplies, in particular to a water discharge valve.

### BACKGROUND

Water discharge valve is an automatic water refill device for a sealed water circulation system. The automatic water refill valve includes a check valve, used to prevent a system water backflow when a pressure of the water refill decreases or the water refill stops.

The existed water discharge valves are connected to thick water pipes, so it is complicated to install the water discharge valves and the water discharge valves are easily damaged.

### SUMMARY

In view of the above deficiency, the present disclosure provides a technical solution that can solve the above problem.

A water discharge valve includes: a base, a threaded seat, a fixing column, an outer housing, and a top cover, the base is fixed with the threaded seat, a top portion of the threaded seat is formed with a connecting column, an outer sidewall of the connecting column is formed with an external thread, a top portion of the threaded seat is provided with a connecting column, the fixing column is hollow, and a bottom of the fixing column defines an opening, an inner wall of the fixing column is formed with an internal thread, the threaded seat is threadedly connected with the fixing column, a first sliding rail and a second sliding rail are arranged on an outer surface of the fixing column, the first sliding rail faces the second sliding rail, the outer housing is vertically sleeved around an outer surface of the fixing column, the outer housing is hollow, a top portion of the outer housing defines an opening, and a bottom portion of the outer housing also defines an opening, an outside wall of the outer housing is fixed with a first latch seat and a second latch seat, the first latch seat is hollow, a left wall of the first latch seat defines an opening, and a right wall of the first latch seat also defines an opening which is extended through the outer housing, the second latch seat is hollow, a left side of the second latch seat defines an opening which is extended through the outer housing, and a right side of the second latch seat also defines an opening, the first latch seat faces the second latch seat, the first latch seat is internally provided with a first latch, a right end of the first latch is connected with the first sliding rail, the second latch seat is internally provided with a second latch, a left end of the second latch is connected with the second slide rail, the top cover is horizontally fixed with the top portion of the outer housing, a bottom of the top cover is connected with the top of the outer housing.

Furthermore, a top portion of the base is horizontally fixed with the threaded seat, a bottom of the threaded seat is fixed with the top portion of the base.

Furthermore, the connecting column is vertically provided on the top portion of the threaded seat.

Furthermore, the internal thread is arranged on a lower portion of the inner wall of the fixing column.

Furthermore, the first sliding rail is arranged on a left side of the outer surface of the fixing column, and the second sliding rail is arranged on a right side of the outer surface of the fixing column

Furthermore, the first latch seat is fixed to a left outside wall of the outer housing.

Furthermore, the second latch seat is fixed to a right outside wall of the outer housing.

Furthermore, the first latch is horizontally provided in the first latch seat.

Furthermore, the second latch is horizontally provided in the second latch seat.

Furthermore, the outer housing is connected to the first sliding rail through the first latch, and the second latch is connected to the second sliding rail, to slidably connect to the fixing column.

Furthermore, a water inlet column is hollow, a top portion of the water inlet column defines an opening which is regarded as a first water inlet, and a bottom portion of the water inlet column also defines an opening.

Furthermore, a second water inlet is defined on a left side of the top portion of the fixing column, and a third water inlet is defined on a right side of the top portion of the fixing column. The second water inlet faces the third water inlet.

Furthermore, the bottom of defines a water outlet, the water outlet extends through the bottom of base and the top of connecting column.

Compared with the prior art, the present disclosure has the following advantages: the water inlet column on the top cover can be connected to a fine household water pipe, the threaded seat can be separated from the fixing column, so it is convenient for storage and transportation, and the water discharge valve is not easily damaged.

The additional aspects and advantages of the present disclosure are given in part in the following description, and another part will become apparent from the description below or will be learned through the practice of the present disclosure.

### BRIEF DESCRIPTION OF THE DRAWINGS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

FIG. 1 is a structure diagram of a water discharge valve of the present disclosure.

FIG. 2 is a structure diagram of a base of the water discharge valve of FIG. 1.

FIG. 3 is a bottom diagram of a threaded seat of the water discharge valve of FIG. 1.

FIG. 4 is a structure diagram of a fixing column of the water discharge valve of FIG. 1.

FIG. 5 is a structure diagram of an outer housing of the water discharge valve of FIG. 1.

FIG. 6 is a structure diagram of a top cover of the water discharge valve of FIG. 1.

In the figures: 1. base, 2. threaded seat, 3. fixing column, 4. outer housing, 5. top cover, 6. fixing column, 7. first latch seat, 8. second latch seat, 9. first sliding rail, 10. second sliding rail, 11. first latch, 12. second latch, 13. first water inlet, 14. second water inlet, 15. third water inlet, 16. water inlet column, 17. water outlet, 18. external thread, 19. internal thread.

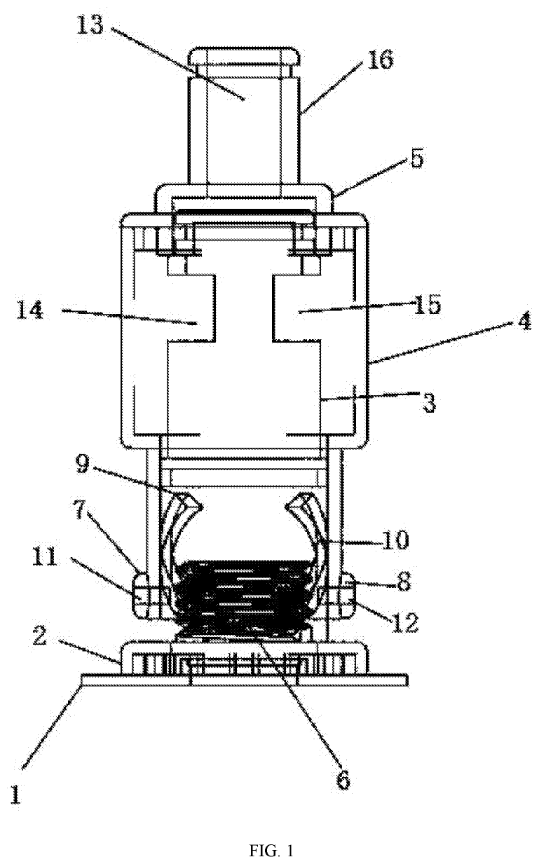

FIG. 1 is a structural diagram of a polyurethane composite floor according to the present disclosure.

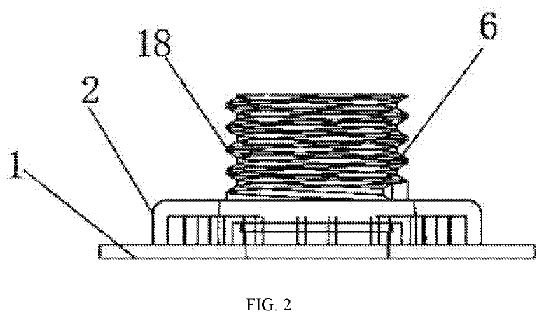

FIG. 2 is another structural diagram of a polyurethane composite floor according to the present disclosure.

### DETAILED DESCRIPTION OF THE EMBODIMENTS

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present invention without creative efforts shall fall within the protection scope of the present invention.

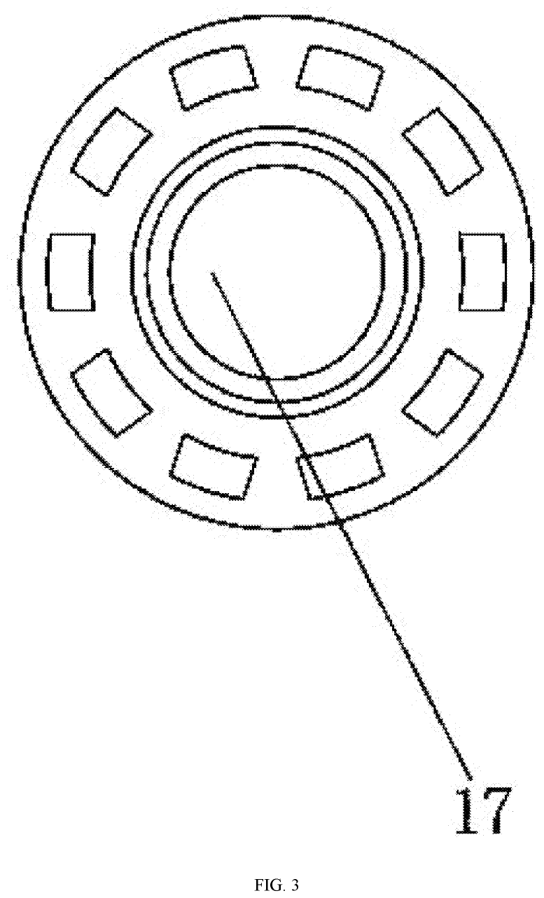

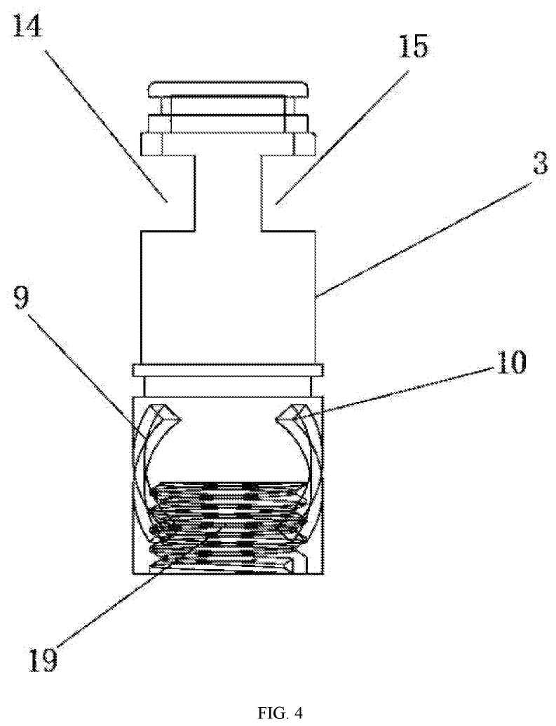

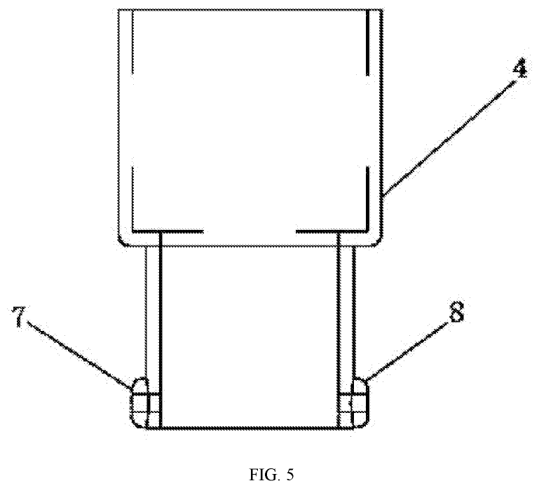

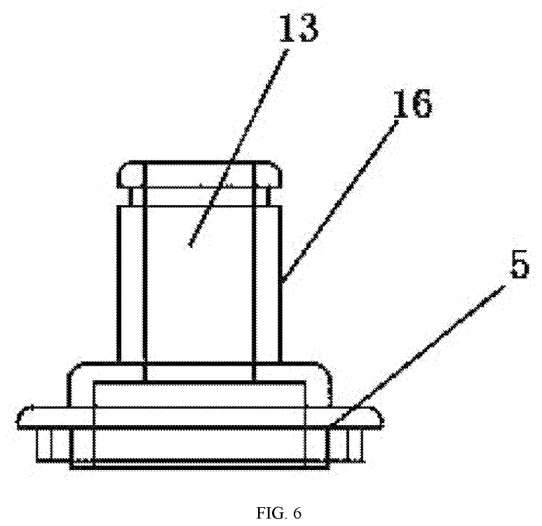

Please referring to FIGS. 1-6, in the embodiments of the present disclosure, the water discharge valve includes a base 1, a threaded seat 2, a fixing column 3, an outer housing 4, and a top cover 5. A top portion of the base 1 is horizontally fixed with the threaded seat 2, a bottom of the threaded seat 2 is fixed with the top portion of the base 1, and a top portion of the threaded seat 2 is provided with a connecting column 6, and an outer sidewall of the connecting column 6 is formed with an external thread 18. A top portion of the connecting column 6 is vertically provided with a fixing column 3, the fixing column 3 is hollow and a bottom of the fixing column 3 defines an opening, a lower portion of an inner wall of the fixing column 3 is formed with an internal thread 19, the threaded seat 2 is threadedly connected with the fixing column 6. A first sliding rail 9 is arranged on a left side of an outer surface of the fixing column 6, and a second sliding rail 10 is arranged on a right side of the outer surface of the fixing column 6. The first sliding rail 9 faces the second sliding rail 10. The outer housing 4 is vertically sleeved around an outer surface of the fixing column 6, the outer housing 4 is hollow, a top portion of the outer housing 4 defines an opening, and a bottom portion of the outer housing 4 also defines an opening. A left outside wall of the outer housing 4 is fixed with a first latch seat 7, the first latch seat 7 is hollow, a left wall of the first latch seat 7 defines an opening, and a right wall of the first latch seat 7 also defines an opening which is extended through the outer housing 4. A right outside wall of the outer housing 4 is fixed with a second latch seat 8, the second latch seat 8 is hollow, a left side of the second latch seat 8 defines an opening which is extended through the outer housing 4, and a right side of the second latch seat 8 also defines an opening, the first latch seat 7 faces the second latch seat 8, the first latch seat 7 is internally and horizontally provided with a first latch 11, a right end of the first latch 11 is connected with the first sliding rail 9, the second latch seat 8 is internally and horizontally provided with a second latch 12, a left end of the second latch 12 is connected with the second slide rail 10. The top cover 5 is horizontally fixed with the top portion of the outer housing 4, a bottom of the top cover 5 is connected with the top of the outer housing 4.

Furthermore, the outer housing 4 is connected to the first sliding rail 9 through the first latch 11, and the second latch 12 is connected to the second sliding rail 10, to slidably connect to the fixing column 3.

Furthermore, a water inlet column 16 is hollow, a top portion of the water inlet column 16 defines an opening which is regarded as a first water inlet 13, and a bottom portion of the water inlet column 16 also defines an opening.

Furthermore, a second water inlet 14 is defined on a left side of the top portion of the fixing column 3, and a third water inlet 15 is defined on a right side of the top portion of the fixing column 3. The second water inlet 14 faces the third water inlet 15.

Furthermore, the bottom of base 1 defines a water outlet 17 which extends through the bottom of base 1 and the top of connecting column 6.

The working principle of the present disclosure includes: an external water pipe is connected to the first water inlet, then the outer housing is rotated to adjust the water inflow.

To the ordinary skilled in the field, it is obvious that the present disclosure is not limited to the details of the above-mentioned exemplary embodiments, and the present disclosure can be realized in other specific forms without deviating from the spirit or basic characteristics of the present disclosure. Therefore, the embodiments shall be regarded as exemplary and non-restrictive embodiments in all respects, and the scope of the present disclosure is defined by the attached claims and not by the above description, thus the present disclosure aims to include all variations within the meaning and scope of the equivalent elements falling within the claims. Any pictorial marks in the claims shall not be regarded as a limitation to the claims.

What is claimed is:

1. A water discharge valve, comprising: a base, a threaded seat, a fixing column, an outer housing, and a top cover, the base is fixed with the threaded seat, a top portion of the threaded seat is formed with a connecting column, an outer sidewall of the connecting column is formed with an external thread, a top portion of the threaded seat is provided with a connecting column, the fixing column is hollow, and a bottom of the fixing column defines an opening, an inner wall of the fixing column is formed with an internal thread, the threaded seat is threadedly connected with the fixing column, a first sliding rail and a second sliding rail are arranged on an outer surface of the fixing column, the first sliding rail faces the second sliding rail, the outer housing is vertically sleeved around an outer surface of the fixing column, the outer housing is hollow, a top portion of the outer housing defines an opening, and a bottom portion of the outer housing also defines an opening, an outside wall of the outer housing is fixed with a first latch seat and a second latch seat, the first latch seat is hollow, a left wall of the first latch seat defines an opening, and a right wall of the first latch seat also defines an opening which is extended through the outer housing, the second latch seat is hollow, a left side of the second latch seat defines an opening which is extended through the outer housing, and a right side of the second latch seat also defines an opening, the first latch seat faces the second latch seat, the first latch seat is internally provided with a first latch, a right end of the first latch is connected with the first sliding rail, the second latch seat is internally provided with a second latch, a left end of the second latch is connected with the second slide rail, the top cover is horizontally fixed with the top portion of the outer housing, a bottom of the top cover is connected with the top of the outer housing.

2. The water discharge valve of claim 1, wherein a top portion of the base is horizontally fixed with the threaded seat, a bottom of the threaded seat is fixed with the top portion of the base.

3. The water discharge valve of claim 1, wherein the connecting column is vertically provided on the top portion of the threaded seat.

4. The water discharge valve of claim 1, wherein the internal thread is arranged on a lower portion of the inner wall of the fixing column.

5. The water discharge valve of claim 1, wherein the first sliding rail is arranged on a left side of the outer surface of the fixing column, and the second sliding rail is arranged on a right side of the outer surface of the fixing column.

6. The water discharge valve of claim 1, wherein the first latch seat is fixed to a left outside wall of the outer housing.

7. The water discharge valve of claim 1, wherein the second latch seat is fixed to a right outside wall of the outer housing.

8. The water discharge valve of claim 1, wherein the first latch is horizontally provided in the first latch seat.

9. The water discharge valve of claim 1, wherein the second latch is horizontally provided in the second latch seat.

10. The water discharge valve of claim 1, wherein the outer housing is connected to the first sliding rail through the first latch, and the second latch is connected to the second sliding rail, to slidably connect to the fixing column.

11. The water discharge valve of claim 1, wherein a water inlet column is hollow, a top portion of the water inlet column defines an opening which is regarded as a first water inlet, and a bottom portion of the water inlet column also defines an opening.

12. The water discharge valve of claim 1, wherein a second water inlet is defined on a left side of the top portion of the fixing column, and a third water inlet is defined on a right side of the top portion of the fixing column, the second water inlet faces the third water inlet.

13. The water discharge valve of claim 1, wherein the bottom of defines a water outlet, the water outlet extends through the bottom of base and the top of connecting column.
